(19) United States
(12) Patent Application Publication
(10) Pub. No.: US 2024/0385876 A1
(43) Pub. Date: Nov. 21, 2024

(54) SELF-CLOCKED ROUND ROBIN SCHEDULER

(71) Applicant: Hewlett Packard Enterprise Development LP, Spring, TX (US)

(72) Inventors: Jean Tourrilhes, Mountain View, CA (US); Puneet Sharma, Palo Alto, CA (US)

(21) Appl. No.: 18/456,709

(22) Filed: Aug. 28, 2023

Related U.S. Application Data
(60) Provisional application No. 63/467,706, filed on May 19, 2023.

(51) Int. Cl. G06F 9/48

(52) U.S. Cl. CPC G06F 9/4881

(57) ABSTRACT

A system maintains ordered sub-queues used for storing packets, which are to be dequeued by a scheduler. A respective is enqueued into a sub-queue, and a virtual time associated with the respective packet is based on a current sub-queue virtual time corresponding to a previously enqueued packet in the sub-queue. The system dequeues, by the scheduler, a first packet from a selected sub-queue and determines a packet virtual time associated with a next packet in the currently selected sub-queue. Responsive to determining that the packet virtual time associated with the next packet is greater than a current global virtual time, the system selects a next sub-queue in the ordered plurality of sub-queues. The system updates the current global virtual time based on a packet virtual time of the dequeued first packet.

### RELATED APPLICATION

This application claims the benefit of U.S. Provisional Application No. 63/467,706, Attorney Docket Number HPE-P171954USPRV, entitled “SELF-CLOCKED ROUND ROBIN,” by inventors Jean Tourrilhes and Puneet Sharma, filed 19 May 2023.

### BACKGROUND

### Field

Multiple streams of data may be merged onto the same network link, requiring schedulers to control how packets of various streams may be merged in order to provide fairness or Quality of Service (QOS) between users of the network link. “Fair Queuing” schedulers can offer the best fairness, but may incur high computational complexity. As a result, most schedulers use a variation of “Deficit Round Robin,” which has a much lower computational complexity and is based on a “quantum” as a fixed unit of scheduling which constrains the granularity of the fairness.

### BRIEF DESCRIPTION OF THE FIGURES

FIG. 1 illustrates an environment which includes a Quality of Service (QOS) controller for scheduling packets, in accordance with an aspect of the present application.

FIG. 2 illustrates an environment which includes a classifier, a plurality of sub-queues, and a scheduler, in accordance with an aspect of the present application.

FIG. 3 illustrates an environment which includes a self-clocked round robin scheduler, in accordance with an aspect of the present application.

FIG. 4A presents a flowchart illustrating a method which facilitates a self-clocked round robin scheduler, including enqueuing operations, in accordance with an aspect of the present application.

FIG. 4B presents a flowchart illustrating a method which facilitates a self-clocked round robin scheduler, including dequeuing operations, in accordance with an aspect of the present application.

FIG. 5A presents a flowchart illustrating a method which facilitates a self-clocked round robin scheduler, in accordance with an aspect of the present application.

FIG. 5B presents a flowchart illustrating a method which facilitates a self-clocked round robin scheduler, in accordance with an aspect of the present application.

FIG. 6 illustrates a computer system which facilitates a self-clocked round robin scheduler, in accordance with an aspect of the present application.

In the figures, like reference numerals refer to the same figure elements.

### DETAILED DESCRIPTION

Aspects of the instant application provide a self-clocked round robin scheduler which improves how packets from multiple streams may be merged (or dequeued from multiple sub-queues) in order to provide fairness and QoS with lower computational complexity than some current schedulers (such as FQ schedulers) while eliminating the use of constraints which limit the granularity of fairness (such as DRR schedulers).

Multiple streams of data may be merged onto the same network link, requiring schedulers to control how packets of various streams may be merged in order to provide fairness or Quality of Service between users of the network link. “Fair Queuing” (FQ) schedulers can offer the best fairness, but may incur high computational complexity. As a result, most schedulers use a variation of “Deficit Round Robin” (DRR), which has a much lower computational complexity and is based on a “quantum” as a fixed unit of scheduling which constrains the granularity of the fairness.

Aspects of the instant application provide a system and method which facilitates a “Self-Clocked Round Robin (SCRR)” scheduler, which can incur a computational complexity similar to DRR schedulers and much lower than FQ schedulers. Specifically, the SCRR scheduler can enqueue packets into sub-queues by tagging packets (similar to FQ), but can dequeue packets in a round robin (RR) manner without looking at all sub-queues for each packet or without having to reorder the sub-queues and without using a quantum. The SCRR scheduler can track a global virtual time which represents the progress in dequeuing packets, and which is based on the virtual time of the packets dequeued in the last round robin cycle through the sub-queues. The SCRR scheduler can enqueue packets using the concept of a tracked virtual time for each sub-queue. The SCRR scheduler can dequeue packets by performing the following for each sub-queue in RR fashion: dequeue one packet from a sub-queue; and determine whether to dequeue the next packet in the same sub-queue or move to the next sub-queue by comparing a packet virtual time of the next packet with the current global virtual time.

The term “global virtual time” can indicate the progress in dequeuing packets, and which is based on the virtual time of the packets dequeued in the last round robin cycle through the sub-queues. The global virtual time can be increased based on the virtual time of the packets dequeued by the scheduler.

The term “sub-queue virtual time” can indicate a most recently enqueued packet in the given sub-queue. The sub-queue virtual time can be incremented based on the size of the packets enqueued in the sub-queue and the sub-queue weight.

The term “packet virtual time” can indicate the virtual time associated with a packet and is based on the virtual time of the sub-queue associated with the packet at the time the packet was enqueued. The term “service tag” may refer to information which can be included in a packet (e.g., appended or prepended), where the packet virtual time may be included in the service tag of the packet. The packet virtual time can be a start time or a finish time associated with the packet.

### Network Queues, Congestion, Sub-Queues, and Schedulers

Network elements (e.g., routers, switches, etc.) may have multiple network links connected to them. A network element can enable the connection of multiple network links to each other and can also forward incoming traffic to the proper outgoing link. Each link may have a finite outgoing capacity and can transmit only one packet at a time. The traffic to be forwarded on a link may arrive from many links and may be unpredictable or bursty. One current solution to handle the mismatch between these incoming and outgoing properties is to implement a queue on the outgoing interface of each link. The queue can store incoming bursts of traffic, and the outgoing interface can send traffic on the link from the queue at the appropriate pace (usually as fast as the link is capable). Thus, a queue can accommodate a temporary excess in input rate by storing packets and smoothing out the processing at the outgoing link.

Networks may be shared by many network applications, which may use different manners of sharing network resources between the applications. One manner is a “best effort” policy, in which the sharing between applications is not managed and instead is only concerned by the overall efficiency of the network. Another manner is “fairness,” which attempts to split some characteristic of the network as equally as possible. Examples of types of fairness may include an equal number of packets, an equal bandwidth, or an equal queuing delay. Yet another manner is network “quality of service” (QoS), which attempts to enforce a QoS policy configured by an administrator of the network. As an example, a QoS policy may define priorities, where applications with higher priority may receive preferential treatment over applications with lower priority. As another example, a QoS policy may limit some of the applications or reserve resources for some of the applications.

In general, most networks can implement a mix of these different manners of sharing network resources between the applications.

As described above, congestion at a queue may occur when the traffic originators sending traffic through a queue are collectively trying to send more traffic than what the queue can process and forward. If the queue is not congested, each user can send as much traffic as it wants, in which case neither fairness nor QoS is an issue. However, if the queue is congested, each user may not be able to send as much traffic as it wants, in which case both fairness and QoS may be a concern.

As a result, queue congestion may strongly affect the fairness and QoS of the network as a whole. A simple queue may only provide a best effort service. More complex queues may implement fairness for traffic going through the bottleneck, e.g., by giving various traffic flows equal treatment. Other complex queues may implement and enforce QoS policies amongst QoS classes.

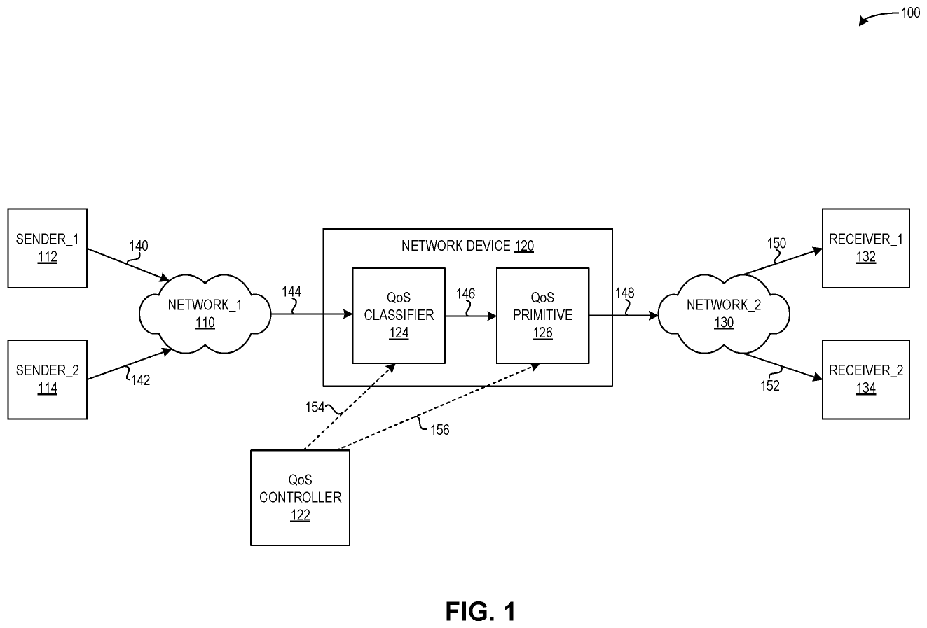

FIG. 1 illustrates an environment 100 which includes a QoS controller 122 for scheduling packets, in accordance with an aspect of the present application. Environment 100 can include multiple network senders which send data to multiple network receivers, where the data may pass through multiple networks and at least one network device. For example, a sender_1 112 and a sender_2 114 can send data (via, respectively, communications 140 and 142) destined for a receiver_1 132 and a receiver_2 134. The data can pass through a network_1 110 to a network device 120 (via a communication 144) and through a network_2 130 (via a communication 148) before being sent onwards to receivers 132 and 134 (via, respectively, communications 150 and 152). Network device 120 can include logic, circuits, elements, units, components, and modules, in hardware or software or a combination, such as a QoS classifier 120 and a QoS primitive 126.

Network device 120 can also include or be associated with a QoS controller 122, which can reside in network device 120 or be accessed or used from a location remote from or external to network device 120. QoS controller 120 can send QoS configurations to both QoS classifier 124 and QoS primitive 126 (via, respectively, communications 154 and 156). QoS classifier 124 can be configured to classify data received from network_1 110 into one of a plurality of classes, where a class can correspond to a certain sub-queue of a plurality of sub-queues. That is, QoS classifier 124 can assign a class to a packet and enqueue the packet into a sub-queue based on the assigned class for the packet. QoS primitive 126 can be configured to dequeue or schedule packets from the sub-queues based on certain policies, including fairness (e.g., an equal number of packets, bytes/bandwidth, and latency for all users) and QoS (e.g., differently allocated bandwidth and latency to users based on priority, percentage, etc.). Congestion may occur in the network device at the point of dequeuing, thus the order in which packets received via 144 are dequeued or scheduled by QoS primitive 126 and subsequently transmitted via 148 can be critical in enforcing fairness and QoS.

One main technique to implement network fairness or network QoS is to use a complex queue structure (e.g., with multiple sub-queues) and a scheduler. The system (or a user) can assign each traffic class or traffic flow to a particular sub-queue. When the queue structure receives a packet, a classifier can select the sub-queue into which to place the packet (e.g., based on packet headers). In the case of First-In-First-Out (FIFO) queues, packets can be enqueued at the tail of a sub-queue. Upon dequeuing, the scheduler can scan the sub-queues and select a sub-queue and the corresponding packet (or packets) at the head of the selected sub-queue. In selecting the sub-queue, the scheduler decides the order in which packets are processed and forwarded. The scheduler can ensure that each traffic class or traffic flow is handled fairly. Given a suitable set of sub-queues, classifier, and scheduler, complex and elaborate QoS policies can be effectively implemented.

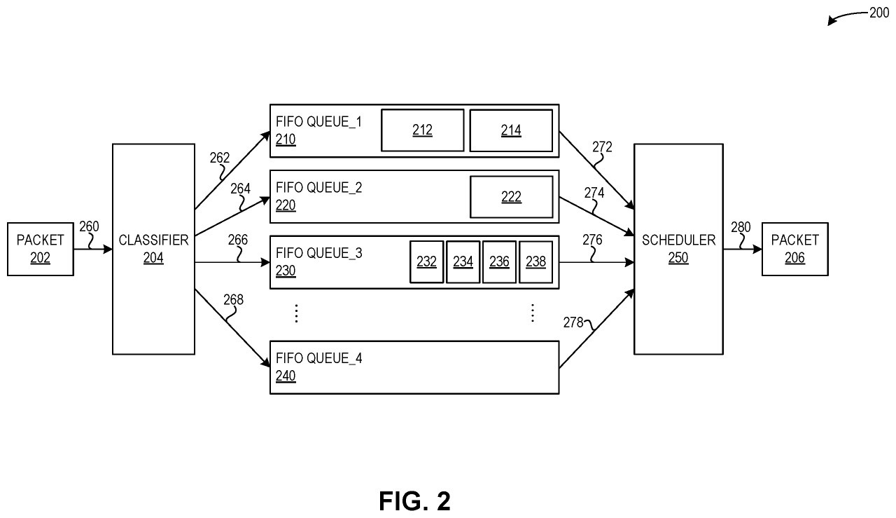

FIG. 2 illustrates an environment 200 which includes a classifier 204, a plurality of sub-queues 210, 220, 230, and 240, and a scheduler 250, in accordance with an aspect of the present application. Sub-queues 210, 220, 230, and 240 can be first in, first out (FIFO) queues. Each queue can be associated with a particular class and include zero or more packets. For example: FIFO queue_1 210 can include at least packets 212 and 214; FIFO queue_2 220 can include at least a packet 222; FIFO queue_3 230 can include at least packets 232, 234, 236, and 238; and FIFO queue_4 240 can include no packets. Environment 200 may include a fewer or greater number of sub-queues than as illustrated in FIG. 2.

In environment 200, a packet 202 can be received by classifier 204, which can assign a class to packet 202. Packet 202 (along with other assigned packets) can be enqueued at the end (i.e., the tail) of one of sub-queues 210, 220, 230, and 240 (via, respectively, 262, 264, 266, and 268) based on the assigned class. Scheduler 250 can determine, based on configured policies to enforce fairness and QoS, an order in which to dequeue the packets of sub-queues 210, 220, 230, and 240 (depicted, respectively, as 272, 274, 276, and 278), where the packets are forwarded, e.g., as a packet 206 (via 280).

Thus, environment 200 depicts multiple sub-queues (210, 220, 230, and 240) that store packets which are directed to and enqueued into the sub-queues based on a classification or class assigned by the classifier (204). The scheduler (250) can be responsible for dequeuing the packets stored in the sub-queues, i.e., scheduling the order in which the packets are to be dequeued from the multiple sub-queues.

### Round Robin Schedulers

Some network schedulers may be based on the “round robin” principle, in which an equal amount of resource is given in turn and in sequence to each traffic class or traffic flow that is congesting the queue structure. A basic Round Robin (RR) scheduler processes in turn one packet of each non-empty sub-queue. The basic RR scheduler can achieve per-packet fairness, where each traffic flow may have an equal number of packets forwarded over time. In a Weighted Round Robin (WRR) scheduler, different weights may be configured for the sub-queues. The WRR scheduler can process packets of the sub-queues in proportion to those weights and can also use the weights to implement some types of QoS policies.

Deficit Round Robin (DRR) is a round robin scheduler based on the notion of a “quantum.” A quantum can represent a number of bytes and is a static, pre-configured value. The DRR scheduler can also keep track of a deficit for each sub-queue. The DRR scheduler can process the sub-queues one after the other, in sequence, and can forward packets from the processed sub-queues. When processing a sub-queue, the DRR scheduler can compute a number of bytes to process by adding the quantum and the sub-queue deficit. The DRR scheduler can subsequently forward as many packets of that sub-queue as allowed based on the computed number of bytes. The unused number of bytes may be stored in the sub-queue as the new deficit. Over time, each congested sub-queue can send the same amount or number of bytes, regardless of packet sizes. Thus, the DRR scheduler can implement per-byte fairness, where each sub-queue is given the same bandwidth. Because the DRR scheduler can process the sub-queues in sequence, the computational complexity of choosing a sub-queue is O(1).

Furthermore, the choice of the quantum can be critical. The granularity of the fairness can be limited by the size of the quantum: a too large quantum may produce large packet bursts from each sub-queue, while a too small quantum may not result in much progress on each sub-queue. For example, if the quantum is smaller than the current packet in the sub-queue, a possible result is that no packet of that sub-queue can be scheduled at the current turn, which can result in unnecessary and wasteful computations. In general, the quantum should be at least as large as the largest packet size, which can help to avoid cycling through the sub-queues without dequeuing or forwarding any packets.

Deficit Weighted Round Robin (DWRR) is a version of the DRR scheduler and uses weights for the sub-queues. When computing the number of bytes, the quantum is multiplied by the weight of the sub-queue.

### Fair Queuing Schedulers

As described above, Fair Queuing (FQ) schedulers aim to achieve the best possible latency fairness and bandwidth fairness with the smallest granularity of fairness. FQ schedulers can emulate the result of a bit-by-bit round robin, while preserving packet boundaries. Compared to the RR schedulers, FQ schedulers can achieve bandwidth fairness. Compared specifically to DRR schedulers, FQ schedulers can implement fairness using a much smaller granularity.

The main issue with most FQ schedulers is that packets need to be dequeued in a specific order, which either requires the scheduler to scan multiple sub-queues to find the packet that needs to be scheduled or to reorder sub-queues in that specific order. As a result, the computational complexity of choosing a sub-queue is usually O(log(n)), where n is the number of sub-queues. This may require more processing than the RR schedulers (which have a complexity of O(1)) and may also limit the scalability of FQ schedulers.

Many versions of FQ schedulers can be modified into Weighted Fair Queuing (WFQ) schedulers by configuring weights for the sub-queues, where the weights can be used to implement some types of QoS policies. A sub-queue weight can be expressed in bytes per second.

Self-Clocked Fair Queuing (SCFQ) is a FQ scheduler that uses the notion of virtual time based on the sub-queues rather than the overall queue structure. The virtual time is effectively related to the byte count progress in a sub-queue. When a packet arrives at the SCFQ queue structure, the system can assign the packet a finish time as its associated packet virtual time. If the sub-queue is empty, the system can set the finish time of the packet to the global virtual time plus the size of the packet in bytes divided by the weight of the sub-queue. If the sub-queue is not empty, the system can set the finish time of the packet as the finish time of the previous packet on that sub-queue plus the size of the packet in bytes divided by the weight of the sub-queue.

To forward a packet, the SCFQ scheduler can scan the sub-queues and select the packet with the lowest finish time (i.e., based on the associated packet virtual time). After forwarding that packet, the SCFQ scheduler can update the global virtual time with the finish time of that forwarded packet.

Start-time Fair Queuing (STFQ) may provide an improvement over SCFQ and can be considered one of the most efficient and fair schedulers. The main difference between STFQ and SCFQ is that STFQ uses the start time of packets instead of the finish time. In STFQ, the packets can be tagged with their start time and scheduled based on their start time. The global virtual time can also be updated using the start time of the packet.

### Description of Self-Clocked Round Robin (SCRR) Scheduler

The described aspects provide a system and method which facilitates a Self-Clocked Round Robin (SCRR) scheduler, which can be considered a hybrid of a Fair Queuing scheduler and a Deficit Round Robin scheduler. The SCRR scheduler can track virtual time based on SCFQ (using the finish time of packets) or STFQ (using the start time of packets), but can schedule the sub-queues in round robin fashion.

The computational complexity of SCRR can be O(1), like DRR, and the granularity of fairness can be lower than that of DRR (in most cases). SCRR can thus provide: fair scheduling of sub-queues in bytes and bandwidth; low computational complexity (O(1)); low fairness granularity; simple, fair, and efficient scheduling of packets; and ease of configuration.

As described above, DRR can be based on a quantum, which needs to be at least as large as the largest packet size, so that each time a non-empty queue is processed, a packet can be forwarded. However, if the network only uses small packets, many packets of the same sub-queue will be scheduled in sequence, as a burst. This can limit the granularity of fairness in DRR.

Most network link technologies may define a maximum packet size. For example, standard Ethernet uses a maximum packet size of 1500 bytes, and Ethernet with Jumbo packets uses a maximum packet size of around 9000 bytes. In order to achieve maximum throughput in traffic flow, a system can use packets of maximum size, which can reduce the relative overhead of packet headers and inter-packet gaps, as those are constant. However, a latency-sensitive (real time) traffic flow may use a packet with a size which is smaller than the maximum size. A smaller packet may consume less time in transmission, and the sender may need to wait less time for a smaller packet to fill with data. As a result, network traffic may use a mix of packet sizes, which may be based on network conditions and thus fluctuate over time. Moreover, network traffic can be generally challenging to predict. Because network traffic can depend upon users and applications, and may also vary over time, the mix of packet sizes in a queue may also be difficult to predict and vary over time.

In some cases, the maximum packet size used by the traffic can be significantly smaller than the maximum size configured on the link (e.g., small voice traffic packets). Ideally, the queue structure should automatically adjust the quantum based on the actual maximum packet size in use on the network. However, scanning the queue structure to check packet sizes can be computationally expensive, while predicting packet size (given traffic-based changes over time) may be difficult.

One alternative is to set a quantum smaller than the maximum packet size. However, this can result in significant inefficiencies when the maximum packet size is used. For example, if the quantum is set at 250 bytes, a sub-queue would need to be scheduled six times to be able to forward a 1500-byte packet.

### Operating Principles of SCRR

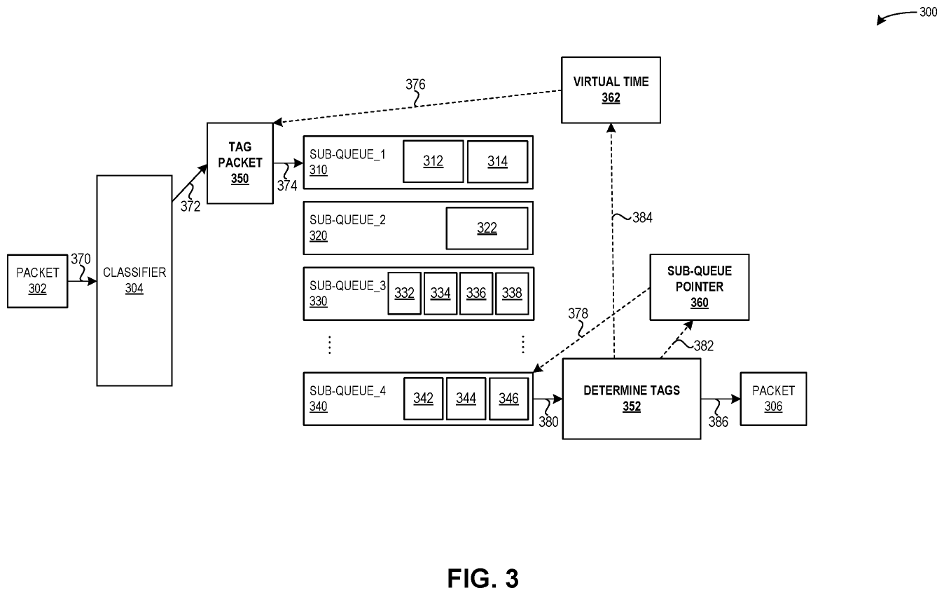

The described aspects of SCRR can eliminate the concept of a quantum by using the virtual time concept of SCFQ and STFQ as well as a novel scheduler. FIG. 3 illustrates an environment 300 which includes a self-clocked round robin scheduler (SCRR), in accordance with an aspect of the present application. Environment 300 can include a classifier 304, a plurality of sub-queues 310, 320, 330, and 340 (i.e., the SCRR queue structure), and scheduling functionality, in accordance with an aspect of the present application. As in environment 200, sub-queues 310, 320, 330, and 340 can be FIFO queues, can each be associated with a particular class, and can include zero or more packets. For example: sub-queue_1 310 can include at least packets 312 and 314; sub-queue_2 320 can include at least a packet 322; sub-queue_3 330 can include at least packets 332, 334, 336, and 338; and sub-queue_4 340 can include at least packets 342, 344, and 346. Environment 300 may include a fewer or greater number of sub-queues than as illustrated in FIG. 3. Scheduler functionality can include performing operations (e.g., a tag packets 350 operation and a determine tags 352 operation) and storing or updating information associated with the SCRR queue structure (e.g., a virtual time 362 and a sub-queue pointer 360). Virtual time 362 can correspond to a current global virtual time for the SCRR queue structure, while sub-queue pointer 360 can correspond to a currently selected sub-queue of the SCRR queue structure.

In environment 300, a packet 302 can be received by classifier 304 (via 370). Classifier 304 can classify packet 302 by assigning a class to packet 302, to be enqueued at the end (i.e., the tail) of the corresponding sub-queue. Upon arrival of packet 302 at the SCRR queue structure (i.e., upon enqueuing into sub-queue_1 310 after classification), the system can tag the packet (operation 350) with a packet virtual time based on SCFQ (using the finish time) or STFQ (using the start time) (via 372 and 374). If the sub-queue is empty, the packet virtual time can be based on the global virtual time (e.g., virtual time 362, obtained via 376). If the sub-queue is not empty, the packet virtual time can be based on the packet virtual time associated with the previous packet (e.g., 312) on that sub-queue plus its size in bytes divided by the weight of the sub-queue.

The SCRR scheduler can perform scheduling of packets (i.e., dequeuing) based on round robin, in which the sub-queues can be an ordered plurality of sub-queues that the SCRR scheduler can process in sequence. As sub-queue pointer 360 tracks the currently selected sub-queue (via 378), the SCRR scheduler can dequeue a packet from the currently selected sub-queue (e.g., a packet 346 via 380) and determine the packet virtual time of dequeued packet 346 (operation 352). The SCRR scheduler can forward the dequeued packet (e.g., as shown by a packet 306 via 386).

The SCRR scheduler can subsequently determine whether to continue dequeuing packets from the same sub-queue or to advance to the next sub-queue. The SCRR scheduler can make this decision by comparing the packet virtual time of the next packet in the same sub-queue with the global virtual time.

For example, if sub-queue_4 340 contains some packets whose packet virtual time is older (i.e., lower) than the global virtual time (362), all those packets can be forwarded in sequence (e.g., via 386). The SCRR scheduler can continue scheduling packets of that sub-queue_4 340 until the next packet has a packet virtual time which is younger (i.e., higher) than the global virtual time. This can allow the sub-queue to catch up with the global virtual time.

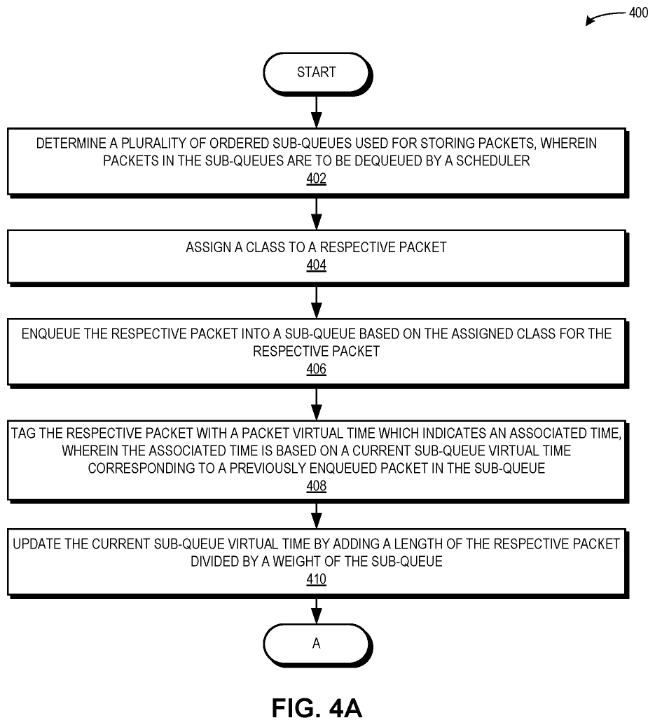

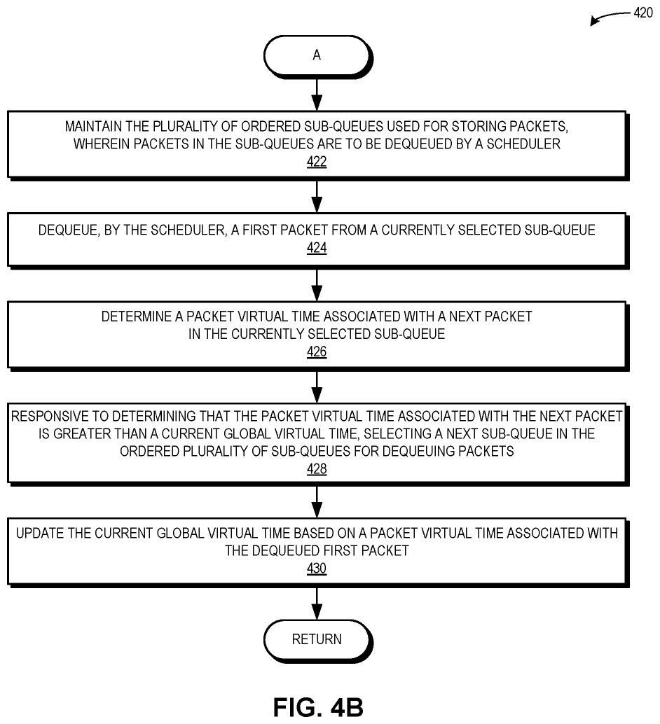

If the sub-queue does not have any packets whose packet virtual time is older (i.e., lower) than the global virtual time, the SCRR scheduler can schedule only the first packet of the sub-queue, potentially update the global virtual time (as described below in relation to FIGS. 4A and 4B) with the associated virtual time of that packet, and move or advance to the next sub-queue (e.g., update sub-queue pointer 360 via 382 to point to the next sub-queue). In a default configuration, the SCRR scheduler can only update the global virtual time (i.e., updates virtual time 362 via 384) once per cycle through the sub-queues in order to constrain the global virtual time to advance by the smallest increment necessary. That is, the SCRR scheduler can advance the global virtual time only once per round robin cycle. If there are n active queues (i.e., sub-queues) in the round robin cycle, after advancing through n sub-queues, the SCRR scheduler can consider the greatest or highest packet virtual time of all the dequeued packets. If this greatest packet virtual time is greater than the global virtual time, the SCRR can update the global virtual time to the value of this greatest packet virtual time (via 384).

The SCRR scheduler can update the global virtual time using different techniques. In a first technique, the global virtual time can be updated with the value of the greatest packet virtual time amongst n packets, irrespective of the previous value of the global virtual time. In a second technique, every time a packet is dequeued, if its packet virtual time is greater than the global virtual time, the global virtual time can be updated with the value of the packet virtual time. Those two techniques can simplify processing at the cost of fairness, and the default version can be a combination of these two techniques.

In the described aspects of the SCRR scheduler, every time a non-empty sub-queue is processed, a packet is guaranteed to be forwarded, which can eliminate wasteful processing. Only a single packet which is greater than the global virtual time can be processed, so in each sub-queue the sub-queue virtual time can only advance beyond the global virtual time by the size of one packet divided by the sub-queue weight. Over a single round robin cycle through the sub-queues, the global virtual time can only advance by the size of the largest forwarded packet divided by the smallest sub-queue weight. This can limit the length of packet bursts, which can be smaller or equal to twice the largest packet size forwarded.

Thus, the SCRR scheduler can effectively implement a round robin scheduler with byte fairness and an adaptive quantum. The adaptive quantum can be the size of the largest dequeued packet in a cycle through the sub-queues.

Scheduling Optimizations with STFQ

As described above, the SCRR scheduler can use the virtual time of SCFQ or STFQ. One advantage of using the virtual time of STFQ is that STFQ can be more fair than SCFQ, which can result in a more fair SCRR scheduler. Another advantage of using the virtual clock of STFQ can be an optimization to the SCRR scheduler. The SCRR scheduler cannot advance to the next sub-queue until all packets older than the global virtual time have been processed. Thus, after processing a packet in a sub-queue, the SCRR scheduler must evaluate the packet virtual time of the next packet in the same sub-queue to determine whether to remain on the same sub-queue or advance to the next sub-queue.

A simple way to make this determination (of whether to stay on the sub-queue or advance to the next sub-queue) is to peek into the sub-queue to check the packet virtual time of the first packet. However, this can involve slightly expensive processing, which can add some overhead due to the memory operations required.

Another way to make this determination is for the SCRR scheduler to use the virtual clock of STFQ, where packets are tagged with their start time. In this case, the start time of the next packet in the sub-queue can be trivially computed, because it is the finish time of the dequeued packet, which is equal to the start time of the dequeued packet plus its size in bytes divided by the weight of the sub-queue, where the sub-queue weight can be expressed in bytes per second. This trivial computation can generally be faster than peeking into the sub-queue.

Yet another way to make this determination is to include in the metadata of each packet the finish time of that packet. When the packet is added to the queue, STFQ can already compute its finish time and save it in the sub-queue structure. As a result, the only modification needed can be to also save the finish time in the metadata of the packet. Upon dequeuing a packet, the SCRR scheduler can read the finish time from the metadata of the packet, where the finish time can be the start time of the next packet in the sub-queue.

The SCRR scheduler can also use an optimization for progressing through the sub-queues. The sub-queues can be separated into two lists (or groups): a first list of empty sub-queues; and a second list of non-empty sub-queues. When advancing to another sub-queue, the SCRR scheduler can select the next sub-queue in sequence in the second list of non-empty sub-queues, which prevents the SCRR scheduler from having to consider empty sub-queues and can result in more efficient processing.

### Method and System for Facilitating SCRR as Per-Packet Processing

In practice, a scheduler can only process one packet at a time, so the SCRR scheduler can be reformulated as per-packet processing. As described above, the SCRR scheduler can use the virtual clock of either STFQ (start time) or SCFQ (finish time) for tagging packets upon enqueuing, determining tags upon dequeuing, and updating the global virtual time. While some of the described aspects recite the use of STFQ and the start time, the SCRR scheduler can also use SCFQ and the finish time.

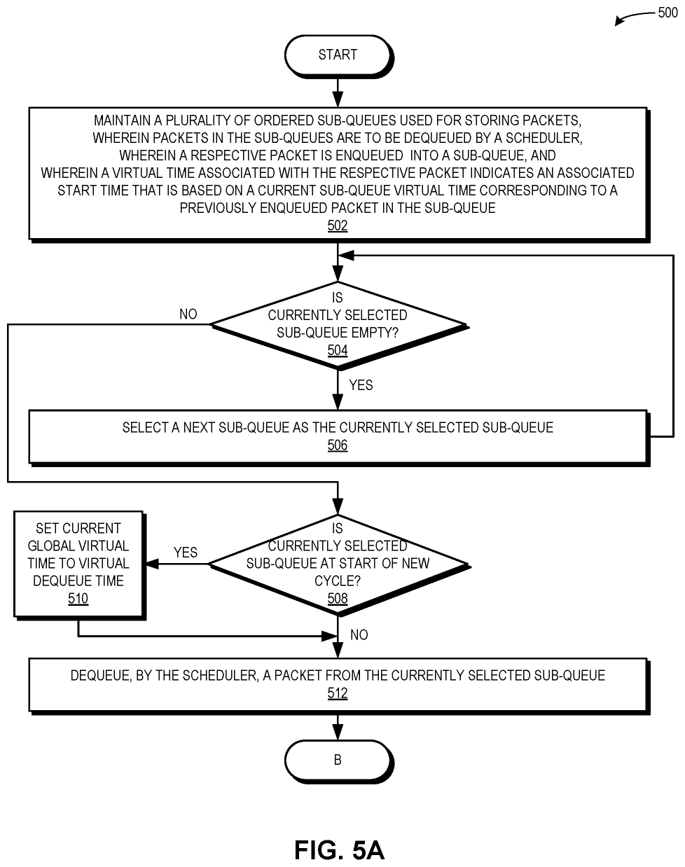

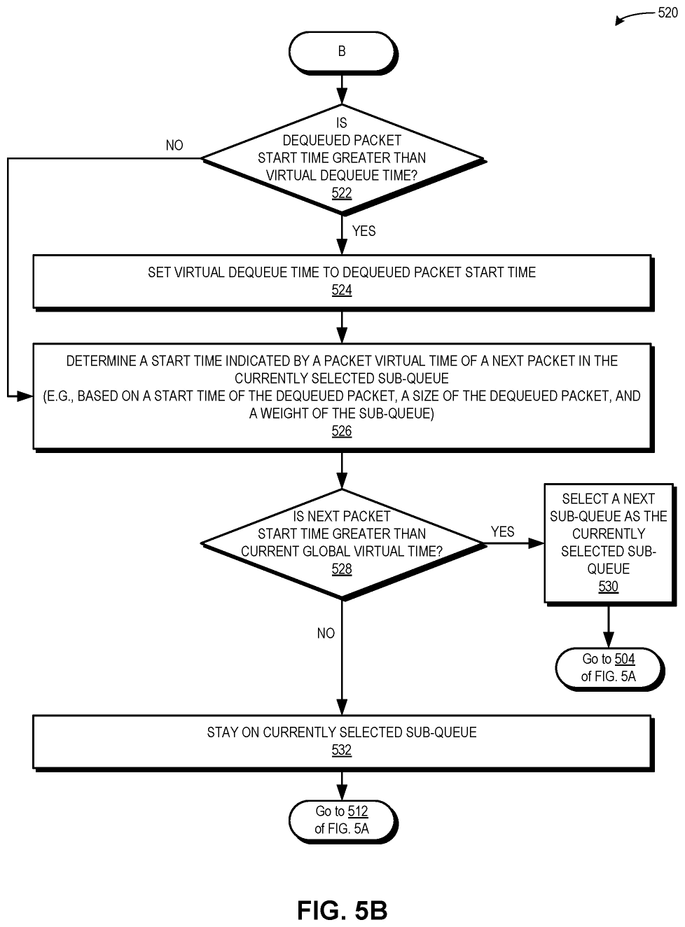

The SCRR scheduler can dequeue a packet from a currently selected sub-queue. If the sub-queue is not empty and the start time of the next packet in the sub-queue is greater than the global virtual time, the SCRR scheduler can advance to the next sub-queue; otherwise, the SCRR scheduler remains on the same sub-queue. If the start time of the dequeued packet is greater than the current virtual dequeue time (“virtual dequeue time,” i.e., the current maximum start time of all dequeued packets), the SCRR scheduler can set the virtual dequeue time to the start time of the dequeued packet. If a full round robin cycle has elapsed since the last update of the current global virtual time, the SCRR scheduler can set the current global virtual time to the virtual dequeue time. These operations are described in detail below in relation to FIGS. 4A, 4B, 5A, and 5B.

FIG. 4A presents a flowchart 400 illustrating a method which facilitates a self-clocked round robin scheduler, including enqueuing operations, in accordance with an aspect of the present application. During operation, the system determines a plurality of ordered sub-queues used for storing packets, wherein packets in the sub-queues are to be dequeued by a scheduler (operation 402). The system assigns a class to a respective packet (operation 404). The system enqueues the respective packet into a sub-queue based on the assigned class for the respective packet (operation 406). The system tags the respective packet with a packet virtual time which indicates an associated time, wherein the associated time is based on a current sub-queue virtual time corresponding to a previously enqueued packet in the sub-queue (operation 408). When using the STFQ scheduler, the associated time can be a start time of the respective packet, wherein the current sub-queue virtual time corresponds to a tail of the most recently enqueued packet in the sub-queue. When using the SCFQ scheduler, the associated time can be a finish time which indicates the current sub-queue virtual time corresponding to the tail of the most recently enqueued packet in the sub-queue plus a length of the respective packet. The system updates the current sub-queue virtual time by adding a length of the respective packet divided by a weight of the sub-queue (operation 410). The operation continues at Label A of FIG. 4B.

FIG. 4B presents a flowchart 420 illustrating a method which facilitates a self-clocked round robin scheduler, including dequeuing operations, in accordance with an aspect of the present application. The system maintains a plurality of ordered sub-queues used for storing packets, wherein packets in the sub-queues are to be dequeued by a scheduler (operation 422). As described above in relation to FIG. 4A, upon enqueuing into a sub-queue, a respective packet is tagged with a packet virtual time which indicates an associated time, wherein the associated time is based on a current sub-queue virtual time corresponding to a previously enqueued packet in the sub-queue. The system dequeues, by the scheduler, a first packet from the currently selected sub-queue (operation 424). The system determines a packet virtual time associated with a next packet in the currently selected sub-queue (operation 426). Responsive to determining that the packet virtual time associated with the next packet is greater than a current global virtual time, the system selects a next sub-queue in the ordered plurality of sub-queues as the currently selected sub-queue for dequeuing packets (operation 428). The system updates the current global virtual time based on a packet virtual time associated with the dequeued first packet (operation 430), and the operation returns.

FIG. 5A presents a flowchart 500 illustrating a method which facilitates a self-clocked round robin scheduler, in accordance with an aspect of the present application. During operation, the system maintains a plurality of ordered sub-queues used for storing packets, wherein packets in the sub-queues are to be dequeued by a scheduler, wherein a respective packet is enqueued into a sub-queue, and wherein a virtual time associated with the respective packet indicates an associated start time that is based on a current sub-queue virtual time corresponding to a previously enqueued packet in the sub-queue (operation 502). If the currently selected sub-queue is empty (e.g., if the first packet is null) (decision 504), the system selects a next sub-queue as the currently selected sub-queue (operation 506), and the operation continues at decision 504. If the currently selected sub-queue is not empty (decision 504), the system determines whether the currently selected sub-queue is at the start of a new round robin cycle (e.g., if the number of sub-queues in the round which have been processed is equal to the total number of sub-queues (decision 508)). If the currently selected sub-queue is at the start of a new round robin cycle (decision 508), the system sets the current global virtual time to the virtual dequeue time (i.e., the maximum start time of all packets dequeued in a single round robin cycle) (operation 510), and the operation continues at operation 512. If the currently selected sub-queue is not at the start of a new round robin cycle (decision 508), the operation continues at operation 512. The system then performs operations to dequeue, by the scheduler, a packet from the currently selected sub-queue (operation 512). The operation continues at Label B of FIG. 5B.

FIG. 5B presents a flowchart 520 illustrating a method which facilitates a self-clocked round robin scheduler, in accordance with an aspect of the present application. If the start time of the dequeued packed is not greater than the virtual dequeue time (decision 522), the operation continues at operation 526. If the start time of the dequeued packet is greater than the virtual dequeue time (decision 522), the system sets the virtual dequeue time to the start time of the dequeued packet (operation 524). The system then performs operations to determine whether to stay on the currently selected sub-queue (i.e., continue dequeuing packets from the currently selected sub-queue) or move to the next sub-queue (i.e., begin dequeuing packets from the next sub-queue). The system determines a start time indicated by a packet virtual time of a next packet in the currently selected sub-queue (operation 526). This can be based on a start time of the dequeued packet, a size of the dequeued packet, and a weight of the sub-queue. If the start time indicated by the packet virtual time of the next packet is greater than a current global virtual time (decision 528), the system selects a next sub-queue in the ordered plurality of sub-queues as the currently selected sub-queue for dequeuing packets (operation 530), and the operation continues at operation 504 of FIG. 5A. While not shown, if as a result of operation 526, the system determines that the next packet does not exist in the sub-queue (i.e., the sub-queue is empty), the system moves to the next sub-queue (i.e., selects a next sub-queue as the currently selected sub-queue, as in operation 530). If the next packet does exist, the operation continues as described for decision 528). If the start time indicated by the packet virtual time of the next packet is not greater than the current global virtual time (decision 528), the system stays on the currently selected sub-queue (operation 532), and the operation continues at operation 512 of FIG. 5A.

FIGS. 5A and 5B illustrate operations for a SCRR scheduler which uses the start time (i.e., STFQ) of packets for tagging packets, dequeuing packets, and updating the global virtual time. However, as described above and in relation to FIGS. 4A and 4B, the SCRR schedule can also use the finish time (i.e., SCFQ) of packets for the same operations.

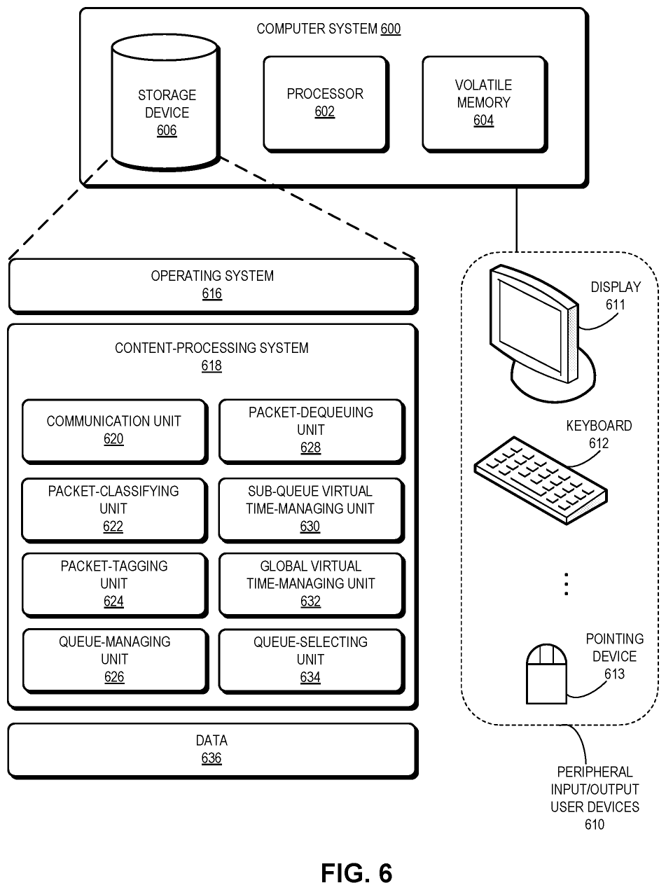

FIG. 6 illustrates a computer system 600 which facilitates a self-clocked round robin scheduler, in accordance with an aspect of the present application. Computer system 600 includes a processor 602, a memory 604, and a storage device 606. Memory 604 can include a volatile memory (e.g., RAM) that serves as a managed memory, and can be used to store one or more memory pools. Furthermore, computer system 600 can be coupled to peripheral input/output (I/O) user devices 610 (e.g., a display device 611, a keyboard 612, and a pointing device 613). Storage device 606 can store an operating system 616, a content-processing system 618, and data 636.

Content-processing system 618 can include instructions, which when executed by computer system 600, can cause computer system 600 to perform methods and/or processes described in this disclosure. Specifically, content-processing system 618 may include instructions for sending and/or receiving data to/from other modules/units/components within computer system 600 or to/from other network nodes across a computer network (communication unit 620).

Content-processing system 618 can further include instructions for maintaining a plurality of ordered sub-queues used for storing packets, wherein packets in the sub-queues are to be dequeued by a scheduler (queue-managing unit 626). Content-processing system 618 can include instructions for dequeuing, by the scheduler, a first packet from a currently selected sub-queue (packet-dequeuing unit 628). Content-processing system 618 can include instructions for determining a packet virtual time associated with a next packet in the currently selected sub-queue (queue-selecting unit 634). Content-processing system 618 can also include instructions for, responsive to determining that the packet virtual time associated with the next packet is greater than a current global virtual time (queue-managing unit 626), selecting a next sub-queue in the ordered plurality of sub-queues for dequeuing packets (queue-selecting unit 634). Content-processing system 618 can include instructions for updating the current global virtual time based on a packet virtual time associated with the dequeued first packet (global virtual time-managing unit 632).

Content-processing system 618 can additionally include instructions for classifying a packet (packet-classifying unit 622) and tagging the packet based on a current sub-queue virtual time corresponding to a previously enqueued packet in the sub-queue (packet-tagging unit 624). Content-processing system 618 can include instructions for updating the current sub-queue virtual time (sub-queue virtual time-managing unit 630) and updating the virtual dequeue time (global virtual time-managing unit 632).

Data 636 can include any data that is required as input or that is generated as output by the methods and/or processes described in this disclosure. Specifically, data 636 can store at least: data; a queue; a plurality of sub-queues; a classification; an enqueued packet; a dequeued packet; a service tag; a virtual time; a start time; a finish time; a global virtual time; a sub-queue virtual time; a virtual dequeue time; an indicator of a currently selected sub-queue; an indicator of a next selected sub-queue; a weight associated with a sub-queue; a size or length of a packet; and a number of bytes.

While FIG. 6 depicts computer system 600 with units 620-634 which may be implemented in software, the described aspects of the SCRR scheduler are not limited to software and may also be implemented in the hardware of an apparatus or a networking device, such as routers and switches. Such an apparatus can comprise a plurality of units or apparatuses which may communicate with one another via a wired, wireless, quantum light, or electrical communication channel. Such an apparatus may be realized using one or more integrated circuits, and may include fewer or more units or apparatuses than those shown in FIG. 6. Further, such an apparatus may be integrated in a computer system, or realized as a separate device which is capable of communicating with other computer systems and/or devices.

### Self Contained Self-Clocked Round Robin

Unlike DRR, the SCRR scheduler is not self contained. The SCRR scheduler requires adding metadata to each packet in the queue structure, and processing is done both at the input of the queues (when packets are enqueued or added to the queue) and at the output of the queues (when packet are dequeued or scheduled).

In some aspects, an approximation of SCRR can be implemented as entirely self contained in the scheduler, including elimination of both packet metadata and input processing, referred to as a self contained SCRR (SC SCRR) scheduler.

When a sub-queue is congested, the SCRR scheduler may perform packet tagging in a predictable fashion, based only on the previous packet in the sub-queue. When the sub-queue is not congested, the SCRR scheduler may compute the virtual time of a packet (i.e., the packet virtual time) from the previous packet or the global virtual time. However, the SCRR scheduler does not have the value of the global virtual time when the packet arrives at the queue to make this decision. To be able to emulate input processing, the self contained SCRR (SC SCRR) scheduler can use a quantum, which should be set to the maximum packet size. Alternatively, the SC SCRR scheduler can use the global virtual time of the previous round robin cycle through the sub-queues to determine if the packet should be tagged based on the previous packet or the global virtual time. Unfortunately, such approximation can result in decreasing the fairness of the scheduler.

The SC SCRR scheduler can perform the following operations. The SC SCRR scheduler can dequeue a packet from a currently selected sub-queue. The SC SCRR scheduler can obtain the finish time of the previous packet in the sub-queue, by retrieving the finish time from the STFQ metadata that SCRR uses to track each sub-queue. The SC SCRR scheduler can then compute the start time of the packet. If the finish time of the previous packet is older than the global virtual time minus the quantum, or older than the global virtual time of the previous round robin cycle, the SC SCRR scheduler can set the start time to the global virtual time; otherwise, the SC SCRR scheduler can set the start time to the finish time of the previous packet. The SC SCRR scheduler can subsequently compute the finish time for that packet (which can be the start time plus the size of the packet in bytes divided by the weight of the sub-queue) and store the finish time in the SCRR metadata associated with the sub-queue.

If the sub-queue is not empty and the finish time of this packet is greater than the global virtual time, the SC SCRR scheduler can advance to the next sub-queue; otherwise, the SC SCRR scheduler can remain on the same sub-queue. If the start time of the dequeued packet is greater than the current dequeue time (i.e., virtual dequeue time), the SC SCRR scheduler can set the virtual dequeue time to that start time. If a full round robin cycle has elapsed since the last update of current global virtual time, the SC SCRR scheduler can set the current global virtual time to the virtual dequeue time.

### Other Technological Areas and Applications

While the described aspects depict the SCRR scheduler operating in the context of networks and networking systems (as described in relation to FIG. 1), the SCRR scheduler can also be applied outside of networks and networking systems. For example, the SCRR scheduler can be used to manage a queue of requests at a server and provide fairness between request streams. In this case, the sub-queues would not contain packets, but would instead contain requests. The requests can be tagged with a service-tag, and the sizes of the requests would need to be determined. All other SCRR scheduler functionality could remain the same.

### Complex Schedulers Using SCRR

The tagging of packets by the SCRR scheduler can be identical to the tagging of packets by STFQ, i.e., the start time computed for each packet can be the same in both schedulers. This can provide the opportunity to combine both SCRR and STFQ in more complex schedulers.

A first design can be a simple multi-queue structure that uses SCRR or STFQ based on the number of active sub-queues. STFQ can be more fair than SCRR on a small scale, but may however be much more resource intensive, where the computations can increase with the number of active flows. The processing constraints may enable the use of STFQ only for a small number of active queues. In such a design, STFQ may only be used if the number of active queues is below a predetermined threshold. If the number of active queues is greater than the predetermined threshold, SCRR can be used. The predetermined threshold can depend upon the computational capability available to the scheduler, so the predetermined threshold could be any number (e.g., “42”). Alternatively, a designer could pick a number and dimension the computation to support it.

Since packet tagging is identical in the SCRR and STFQ schedulers, the queue structure can instantaneously and transparently switch between SCRR and STFQ based on the number of active queues. During the switch, no packets are lost and the long term fairness is not impacted. The only impact of the change may be in the short term fairness and the amount of computing resources used.

A second design can be a hierarchical scheduler implementing both priorities and fairness or QoS. The top level policy of the scheduler can be based on priorities, e.g., strict priority. Within each priority, SCRR or STFQ can be used to provide fairness or QoS. The scheduler can use STFQ for the high priority sub-queues to maximize fairness or QoS, and the scheduler can use SCRR for the low priority sub-queues to maximize efficiency.

An advantage of using the SCRR scheduler for the low priority sub-queues over DRR is that the overall design can be simpler. The processing for enqueuing packets can be exactly the same for STFQ and SCRR, and very similar for dequeuing packet, so most processing is common and can be shared between priority queues.

### Aspects and Variations of the Instant Application

In general, the disclosed aspects provide a method, computer system, and non-transitory computer-readable storage medium for facilitating a self-clocked round robin scheduler. In one aspect, the system maintains a plurality of ordered sub-queues used for storing packets, wherein packets in the sub-queues are to be dequeued by a scheduler, wherein a respective packet is enqueued into a sub-queue, and wherein a virtual time associated with the respective packet is based on a current sub-queue virtual time corresponding to a previously enqueued packet in the sub-queue. The system dequeues, by the scheduler, a first packet from a currently selected sub-queue. The system determines a packet virtual time associated with a next packet in the currently selected sub-queue. Responsive to determining that the packet virtual time associated with the next packet is greater than a current global virtual time, the system selects a next sub-queue in the ordered plurality of sub-queues for dequeuing packets. The system updates the current global virtual time based on a packet virtual time associated with the dequeued first packet.

In a variation on this aspect, responsive to determining that the packet virtual time associated with the dequeued first packet is greater than the current global virtual time, the system updates the current global virtual time to the packet virtual time associated with the dequeued first packet. Responsive to determining that the packet virtual time associated with the dequeued first packet is not greater than the current global virtual time, the system refrains from updating the current global virtual time.

In a further variation on this aspect, a virtual dequeue time tracks a greatest virtual time indicated by packet virtual times of all packets dequeued in a single cycle of dequeuing packets from each of the ordered plurality of sub-queues. Responsive to determining that the packet virtual time associated with the dequeued first packet is greater than the virtual dequeue time, the system updates the virtual dequeue time to the packet virtual time associated with the dequeued first packet. Responsive to determining that the packet virtual time associated with the dequeued first packet is not greater than the virtual dequeue time, the system refrains from updating the virtual dequeue time.

In a further variation, responsive to completing the single cycle of dequeuing packets from each of the ordered plurality of sub-queues or responsive to a predetermined number of packets being dequeued from the ordered plurality of sub-queues, the system sets the current global virtual time to the virtual dequeue time. The predetermined number can be based on one or more of, e.g.: the number of packets; the number of active sub-queues; a maximum packet size; and an average packet size. In one aspect, the pre-determined number can be based on a ratio of the maximum packet size to the average packet size multiplied by the number of active sub-queues

In a further variation, the system determines the packet virtual time associated with the next packet by extracting information from the service tag of the next packet to be dequeued in the currently selected sub-queue.

In a further variation, the system determines the packet virtual time associated with the next packet by computing the virtual time of the next packet based on the packet virtual time associated with the dequeued first packet and a size of the dequeued first packet.

In a further variation, the system determines the packet virtual time associated with the next packet by reading a virtual time from metadata associated with the dequeued first packet.

In a further variation, selecting the next sub-queue in the ordered plurality of sub-queues is based on a sequence of non-empty sub-queues of the plurality of sub-queues.

In a further variation, the system determines the virtual time associated with the respective packet based on at least one of: a packet virtual time associated with a previous packet in the same sub-queue; a configured weight for the sub-queue; a size of the previous packet; a size of the respective packet; and the current global virtual time.

In a further variation, the virtual time associated with the respective packet comprises one of: a start time, wherein the current sub-queue virtual time corresponds to a tail of the most recently enqueued packet in the sub-queue; and a finish time which indicates the current sub-queue virtual time corresponding to the tail of the most recently enqueued packet in the sub-queue plus a length of the respective packet

In another aspect, a computer system comprises a processor and a storage device which stores instructions that when executed by the processor cause the processor to perform the method as described above, including in relation to FIGS. 3, 4A, 4B, 5A, and 5B.

In yet aspect, a non-transitory computer-readable storage medium stores instructions that when executed by a computer cause the computer to perform the method described above, including in relation to FIGS. 3, 4A, 4B, 5A, and 5B.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method for scheduling packets to be processed, the method comprising:
maintaining a plurality of ordered sub-queues used for storing packets, wherein packets in the sub-queues are to be dequeued by a scheduler,
wherein a respective packet is enqueued into a sub-queue, and wherein a virtual time associated with the respective packet is based on a current sub-queue virtual time corresponding to a previously enqueued packet in the sub-queue;
dequeuing, by the scheduler, a first packet from a currently selected sub-queue;
determining a packet virtual time associated with a next packet in the currently selected sub-queue;
responsive to determining that the packet virtual time associated with the next packet is greater than a current global virtual time, selecting a next sub-queue in the ordered plurality of sub-queues for dequeuing packets; and
updating the current global virtual time based on a packet virtual time associated with the dequeued first packet.

2. The method of claim 1, comprising:
responsive to determining that the packet virtual time associated with the dequeued first packet is greater than the current global virtual time, updating the current global virtual time to the packet virtual time associated with the dequeued first packet; and
responsive to determining that the packet virtual time associated with the dequeued first packet is not greater than the current global virtual time, refraining from updating the current global virtual time.

3. The method of claim 1, wherein a virtual dequeue time tracks a greatest virtual time indicated by packet virtual times of all packets dequeued in a single cycle of dequeuing packets from each of the ordered plurality of sub-queues, and wherein the method further comprises:
responsive to determining that the packet virtual time associated with the dequeued first packet is greater than the virtual dequeue time, updating the virtual dequeue time to the packet virtual time associated with the dequeued first packet; and
responsive to determining that the packet virtual time associated with the dequeued first packet is not greater than the virtual dequeue time, refraining from updating the virtual dequeue time.

4. The method of claim 3, further comprising:
responsive to completing the single cycle of dequeuing packets from each of the ordered plurality of sub-queues or responsive to a predetermined number of packets being dequeued from the ordered plurality of sub-queues, setting the current global virtual time to the virtual dequeue time.

5. The method of claim 1, further comprising:
determining the packet virtual time associated with the next packet by extracting information from a service tag of the next packet to be dequeued in the currently selected sub-queue.

6. The method of claim 1, further comprising:
determining the packet virtual time associated with the next packet by computing the virtual time of the next packet based on the packet virtual time associated with the dequeued first packet, a configured weight for the sub-queue, and a size of the dequeued first packet.

7. The method of claim 1, further comprising:
determining the packet virtual time associated with the next packet by reading a virtual time from metadata associated with the dequeued first packet.

8. The method of claim 1,
wherein selecting the next sub-queue in the ordered plurality of sub-queues is based on a sequence of non-empty sub-queues of the plurality of sub-queues.

9. The method of claim 1, further comprising determining the virtual time associated with the respective packet based on at least one of:
a packet virtual time associated with a previous packet in the same sub-queue;
a configured weight for the sub-queue;
a size of the previous packet;
a size of the respective packet; and
the current global virtual time.

10. The method of claim 1, wherein the virtual time associated with the respective packet comprises one of:
a start time, wherein the current sub-queue virtual time corresponds to a tail of the most recently enqueued packet in the sub-queue; and
a finish time which indicates the current sub-queue virtual time corresponding to the tail of the most recently enqueued packet in the sub-queue plus a length of the respective packet.

11. A computer system, comprising:
a processor; and
a storage device storing instructions that when executed by the processor cause the processor to perform a method, the method comprising:
maintaining a plurality of ordered sub-queues used for storing packets, wherein packets in the sub-queues are to be dequeued by a scheduler,
wherein a respective packet is enqueued into a sub-queue, and wherein a virtual time associated with the respective packet is based on a current sub-queue virtual time corresponding to a previously enqueued packet in the sub-queue;
dequeuing, by the scheduler, a first packet from a currently selected sub-queue;
determining a packet virtual time associated with a next packet in the currently selected sub-queue;
responsive to determining that the packet virtual time associated with the next packet is greater than a current global virtual time, selecting a next sub-queue in the ordered plurality of sub-queues for dequeuing packets; and
updating the current global virtual time based on a packet virtual time associated with the dequeued first packet.

12. The computer system of claim 11, wherein the method further comprises:
responsive to determining that the packet virtual time associated with the dequeued first packet is greater than the current global virtual time, updating the current global virtual time to the packet virtual time associated with the dequeued first packet; and
responsive to determining that the packet virtual time associated with the dequeued first packet is not greater than the current global virtual time, refraining from updating the current global virtual time.

13. The computer system of claim 11, wherein a virtual dequeue time tracks a greatest virtual time indicated by packet virtual times of all packets dequeued in a single cycle of dequeuing packets from each of the ordered plurality of sub-queues, and wherein the method further comprises:
responsive to determining that the packet virtual time associated with the dequeued first packet is greater than the virtual dequeue time, updating the virtual dequeue time to the packet virtual time associated with the dequeued first packet; and
responsive to determining that the packet virtual time associated with the dequeued first packet is not greater than the virtual dequeue time, refraining from updating the virtual dequeue time.

14. The computer system of claim 13, wherein the method further comprises:
responsive to completing the single cycle of dequeuing packets from each of the ordered plurality of sub-queues or responsive to a predetermined number of packets being dequeued from the ordered plurality of sub-queues, setting the current global virtual time to the virtual dequeue time.

15. The computer system of claim 11, wherein the method further comprises:
determining the packet virtual time associated with the next packet by extracting information from a service tag of the next packet to be dequeued in the currently selected sub-queue.

16. The computer system of claim 11, wherein the method further comprises:
determining the packet virtual time associated with the next packet by computing the virtual time of the next packet based on the packet virtual time associated with the dequeued first packet and a size of the dequeued first packet.

17. The computer system of claim 11, wherein the method further comprises:
determining the packet virtual time associated with the next packet by reading a virtual time from metadata associated with the dequeued first packet.

18. The computer system of claim 11, wherein the method further comprises determining the virtual time associated with the respective packet based on at least 2 one of:
a packet virtual time associated with a previous packet in the same sub-queue;
a configured weight for the sub-queue;
a size of the previous packet;
a size of the respective packet; and
the current global virtual time.

19. The computer system of claim 11, wherein the virtual time associated with the respective packet comprises one of:
a start time, wherein the current sub-queue virtual time corresponds to a tail of the most recently enqueued packet in the sub-queue; and
a finish time which indicates the current sub-queue virtual time corresponding to the tail of the most recently enqueued packet in the sub-queue plus a length of the respective packet.

20. A non-transitory computer-readable storage medium storing instructions that when executed by a computer cause the computer to perform a method, the method comprising:
maintaining a plurality of ordered sub-queues used for storing packets, wherein packets in the sub-queues are to be dequeued by a scheduler,
wherein a respective packet is enqueued into a sub-queue, and wherein a virtual time associated with the respective packet is based on a current sub-queue virtual time corresponding to a previously enqueued packet in the sub-queue;
dequeuing, by the scheduler, a first packet from a currently selected sub-queue;
determining a packet virtual time associated with a next packet in the currently selected sub-queue;
responsive to determining that the packet virtual time associated with the next packet is greater than a current global virtual time, selecting a next sub-queue in the ordered plurality of sub-queues for dequeuing packets; and
updating the current global virtual time based on a packet virtual time associated with the dequeued first packet.
